(19) United States
(12) Patent Application Publication
(10) Pub. No.: US 2018/0290152 A1
(43) Pub. Date: Oct. 11, 2018

(54) SEPARATOR

(71) Applicant: GEA MECHANICAL EQUIPMENT GMBH, Oelde (DE)

(72) Inventors: Wilfried MACKEL, Lippetal-Herzfeld (DE); Thomas BATHELT, Oelde (DE); Kathrin QUITER, Drensteinfurt (DE); Frank TAETZ, Delbrück (DE); Kai HELMRICH, Drensteinfurt (DE)

(21) Appl. No.: 15/766,111

(22) PCT Filed: Jun. 3, 2016
(86) PCT No.: PCT/EP2016/062700

§ 371 Date: Apr. 5, 2018

(30) Foreign Application Priority Data
Oct. 13, 2015 (DE) 10 2015 117 375.1

(51) Int. Cl. B04B 11/02; B04B 1/08; B04B 7/04; B04B 7/14

(52) U.S. Cl. CPC B04B 11/02; B04B 7/14; B04B 7/04; B04B 1/08

(57) ABSTRACT

A separator for the centrifugal processing of a free-flowing product includes a rotatable drum with a vertical rotation axis. The rotatable drum has a centrifuging chamber and a maximum radial diameter. An annular cover is placed onto an upper end of the drum and is configured as a part that does not rotate with the drum during operation. At least one sealing arrangement with two sealing rings is arranged between the drum and the annular cover. A leakage chamber having an outlet is formed between the two sealing rings of the at least one sealing arrangement. A splash ring, which is fastened to the drum for rotation therewith, is arranged in the leakage chamber.

### BACKGROUND AND SUMMARY OF THE INVENTION

Exemplary embodiments of the invention relate to a separator for centrifugal processing of a flowable product.

Centrifugal separators for ensuring continuous operation have long been known, for instance configured as nozzle-type separators in Japanese patent document JP 62-1 276 49 A. In addition to nozzle-type separators, separators with solids discharge orifices are also known, which are associated with a hydraulically actuatable piston valve with which the solids discharge orifices may be opened and closed. A separator without solids discharge and embodied as a divider is disclosed in United States patent document U.S. Pat. No. 2,017,734. Furthermore, a separator with solid, screwed-together upper and lower drum parts is disclosed in United States patent document U.S. Pat. No. 2,286,354.

Moreover, PCT International patent document WO 2014/000829 A1 discloses a separator for separating a flowable product into different phases or for clarifying a product, which comprises a rotatable drum with a lower drum part and an upper drum part and a clarifying means arranged in the drum, wherein one, a plurality or all of the following elements consist of plastics or a plastics composite material: the lower drum part, the upper drum part, the clarifying means. This makes it possible to design one part of the drum or preferably even the entire drum, preferably together with the in- and outflow systems and/or regions, to be suitable for single use, which is of interest and advantageous in particular with regard to the processing of pharmaceutical products such as fermentation broths or the like, since it is not necessary to clean the drum after operation to process a corresponding product batch with preferably continuous operation for processing of the product batch, but rather the drum as a whole may be replaced. This separator is thus very advantageous precisely from a hygiene viewpoint.

It is therefore desirable, and this is the object of the invention, further to improve the operating characteristics and, according to one variant, preferably also to improve the handling characteristics of the design of the generic type.

According to an embodiment, a separator for centrifugal processing of a flowable product, in particular operating continuously, includes at least the following features: a rotatable drum with a vertical axis of rotation, which comprises a centrifuging chamber and has a maximum radial diameter, an annular cover member placed on the upper end of the drum and which is configured as a part that does not rotate with the drum during operation, at least one sealing arrangement with two sealing rings further being arranged between the drum and the annular cover member, wherein between the two sealing rings of the at least one sealing arrangement a leakage chamber is provided which has a discharge line, wherein a splash ring fastened non-rotatably to the drum is formed or arranged in the leakage chamber. The splash ring ensures in a simple manner that liquid between the seals, this being in particular a leakage liquid, is splashed radially outwards between the seals in the leakage chamber, where it is discharged from the drum through the discharge line. The splash ring in this respect substantially prevents leakage liquid from flowing through to the lower seal. In this respect, it is preferable and convenient for the sealing arrangement with the splash ring to be a vertically bottommost sealing arrangement of a plurality of sealing arrangements arranged vertically one above the other.

It is structurally simple for the splash ring to be an annular disk fastened non-rotatably to the drum by its inner circumference such that it rotates therewith during operation.

According to a preferred variant of the invention, the bottommost seal is non-rotatably arranged internally on the annular cover member and a gap is formed between the bottommost of the seals of the at least one sealing arrangement or the plurality of sealing arrangements and the drum. In this way, excessive evolution of heat at this seal is avoided. The splash ring additionally ensures that no or virtually no leakage liquid reaches this seal. It has proven sufficient for the annular gap to have a radial gap width of more than 0 mm and less than 5 mm. It is favorable for it to have a radial gap width of between 0.2 mm and 1 mm.

Embodiments of the invention are particularly suitable for a separator having drum comprising an outer drum and an inner drum arranged in the outer supporting device.

It is advantageous for the separator to comprise a housing that does not rotate during operation, which accommodates the drum, and which is in turn preferably dimensioned such that the entire drum, with the outer drum and the inner drum, is arranged inside the housing. In this case, it is advisable for the annular cover member to be supported non-rotatably on the housing via a means with limited mobility. This further development, which is also to be considered a separate invention, ensures the annular cover member does not rotate with the drum, wherein the means with limited mobility prevents excessive evolution of heat, in particular at seals between the annular cover member and the drum.

According to one variant of the further development and indeed separate invention explained above, the housing comprises one or more feedthroughs for feed and/or discharge lines to/from the annular cover member, wherein these feed and/or discharge lines constitute the means with limited mobility.

This may readily be ensured in that the feed and/or discharge lines are guided at one end to the annular cover member and fastened thereto and in that they are each secured at their other end to a corresponding feedthrough of the housing or pass therethrough.

According to one variant, it is simple and convenient for the feed and/or discharge lines to take the form of flexible hoses. The term “hose” should not be interpreted too narrowly. To a limited extent, it also includes resilient tubes.

According to one variant, it is also advantageous for individual or multiple feed and/or discharge lines to take the form of dimensionally stable hoses. For the purposes of the present application, dimensionally stable means with regard to these hoses that they are made in such a way that, although their shape is variable to a limited degree, they return or substantially return to their original shape after a change in shape in a manner similar to a resiliently deformable body.

According to further advantageous variants, provision is made for individual or multiple feed and/or discharge lines to take the form of repeatedly bent hoses. In this case, it is advisable for individual or multiple hoses to have alternately straight portions and bends, which are of one-piece construction or indeed may be made up from multiple pieces assembled into an overall structure. This makes it straightforwardly possible to ensure that individual or multiple feed and/or discharge lines have lower rigidity in the radial direction than in the axial direction relative to the axis of rotation of the drum when installed between annular cover member and housing. In this way, excursions of the rotating system in the radial direction are advantageously compensated, whereas axially a higher rigidity is advantageously achieved.

According to another variant of the above-explained further development and indeed separate invention, the means with limited mobility in contrast takes the form of a supporting yoke, which is in itself resiliently mobile to a limited degree and/or which is arranged to be mobile to a limited degree at one or both ends, i.e., at the housing and/or at the annular cover member. In this way too, excessive evolution of heat at seals of the annular cover member is simply prevented. In this case, it is structurally simple for the supporting yoke to be vertically oriented between the ends thereof.

Preferably, moreover, a means for clarifying the product to be processed in the centrifugal field is arranged in the inner drum. This again provides a straightforward way of markedly improving the running behavior of the rotating system, in particular of the drum, since the outer supporting device stabilizes the system. Since this support device is located radially outside the drum wall, which defines the inner chamber of the drum, the actual drum defining the centrifuging chamber is designated the “inner drum”.

According to an advantageous further development, the outer drum is configured such that it completely or partly surrounds the inner drum. This provides a particularly simple way of markedly improving the running behavior of the rotating system, in particular of the drum, because the outer drum dynamically and mechanically stabilizes the system. Not only deflections of the rotating system in the radial direction relative to the axis of rotation D but also the tendency to imbalance may be markedly reduced. Both the inner drum and also the outer drum as an advantageous supporting structure may be, but are not necessarily, of relatively thin-walled or light construction. In particular, the inner drum preferably to be exchanged after processing of a product batch may in this way be manufactured with very small amounts of material.

Nevertheless, it remains possible to exploit the advantages of “plastics” or “plastics composite” material, since it is furthermore possible to design a part of the drum (the inner drum and preferably the constituents thereof, in particular together with the in- and outflow systems and/or regions) for single use, such that no cleaning of the drum has to be performed after operation to process a corresponding product batch with preferably continuous and hygienic operation for processing the product batch, but rather the drum as a whole is replaced. This replacement is therefore particularly simple, since the outer drum, which is preferably reused, does not require any major cleaning, since it preferably does not come into contact at all with the product to be processed. It therefore does not have to be cleaned every time the inner drum is exchanged or has to be only relatively briefly cleaned and/or disinfected.

Although the outer drum may completely surround the inner drum, the rotating system is also well stabilized if the outer drum surrounds the inner drum axially only in places, preferably in any event over a part of the axial vertical length of a conical portion of the upper part of the inner drum.

In the latter case it is advantageous for the inner drum to project upwards a little axially from the outer drum, which makes it easier clearly to divide and space the in- and outflow region of the inner drum from the outer drum.

It is particularly advantageous for the inner drum and the outer drum to consist of different materials, which allows selection of the optimal materials for each of the two elements outer drum and inner drum. The inner drum preferably consists of a plastics or plastics composite material, which is in turn preferably relatively thin-walled, such that it may be readily disposed of, while the reusable outer drum preferably consists of metal, in particular of steel, such that its running characteristics may be particularly well optimized.

This is also advantageous in that, when a metallic outer drum and a plastics inner drum are used, the weight of the outer drum may significantly exceed that of the inner drum, such that rotational behavior is substantially determined by the outer drum. To this end, the weight of the rotating parts of the metallic outer drum is preferably more than twice, in particular more than four times the weight of the plastics rotating parts or the weight of the empty inner drum. The outer drum also makes it possible to make the inner drum particularly thin-walled, since it is stabilized by the outer drum.

In order to be able to insert the inner drum readily and simply into the outer drum, it is advantageous for the outer drum to have an outer drum lower part and an outer drum upper part detachable therefrom. In contrast, it is advantageous substantially for manufacturing reasons for the inner drum to comprise an inner drum lower part and an inner drum upper part preassemblable or preassembled therewith. This is because it is necessary during production to place various elements in the inner drum, such as the clarifying means, an inflow pipe and the like, which is simplified by dividing it into an upper part and a lower part.

Mounting of the inner drum in the outer drum is particularly simple if the outer drum upper part is configured as a ring that is screwed together with the outer drum lower part and which is axially open at the top, such that the inner drum upper part projects axially therefrom. The outer drum lower part and the outer drum upper part may also be connected in some other way. An advantageous variant is a threaded bolt connection. A bayonet fitting is also a feasible connecting means. Finally, it is advantageous to connect the outer drum upper part and the outer drum lower part together or fix them relative to one another using an obturating ring. To this end, a lower edge of the outer drum upper part is preferably inserted into the outer drum lower part, where it may rest on a collar. A ring with external thread is then screwed from above into an internal thread of the outer drum lower part, which ring fixes the outer drum upper part to the outer drum lower part.

To ensure reliable rotation as far as possible without slip between the inner drum and the outer drum, it is advantageous for the inner drum and the outer drum to be non-rotatably connected together in a force- and/or form-locked manner.

For reasons of hygiene, it is furthermore advantageous for an inflow system and an outflow system of the drum to be provided exclusively on the inner drum, such that the outer drum does not come into contact with the product to be processed when in operation. The inflow system and the outflow system are preferably formed on the inner drum in a sealed construction.

In a further configuration, it is advantageous for the inflow system and the outflow system to comprise the annular cover member configured as a part that does not rotate with the drum during operation and for the inflow system to further comprise an inflow pipe configured as an element that does rotate with the drum. In this way, transfer of the product into the rotating system takes place as early as at the intake of the inflow pipe, which simplifies the structure of the inner drum.

Overall, it is particularly advantageous for handling reasons for the entire inner drum together with the in- and outflow system to be designed as an exchangeable, preassembled module of plastics or of a plastics composite material. It is also feasible to a limited degree to provide further local reinforcements, for example of metal or plastics or another suitable material.

In this case, the outer drum upper part is intended to comprise a central opening having a size to allow it to be placed from above over the annular cover member with its feed and discharge line ports and hoses optionally attached thereto, which then have merely to be connected after assembly. This makes it particularly quick and easy to assemble the inner drum after removal of the outer drum upper part.

The means for clarifying a product to be processed from a phase containing more solids in proportion by volume than the other phase, is preferably again a separator disk stack of conical separator disks of plastics, but may for example also be a one-piece clarification/precipitation insert of plastics in the manner of German patent document DE 10 2008 052 630 A1 or another means of clarifying a product of solid particles, such as a ribbed body with radial ribs or the like. The separator drum is preferably used to this end to further concentrate a product, i.e., the clarifying means is used to separate a phase containing more solids per unit volume but is preferably still just flowable from a phase containing fewer solids. The term “clarifying means” should in this respect be interpreted in relative terms. It also relates to this application, wherein here the clarifying means serves further to concentrate the product or in recovery of a concentrated phase.

Overall, given the design of the inner drum, some and preferably even all of the regions of the rotating system coming into contact with the product, in particular the inner drum lower part and the inner drum upper part and the disk stack, consist of a plastic or a plastics composite material. Particularly preferably, the inflow system and the outflow system further consist of plastics or a plastics composite material.

It is particularly advantageous for all the parts of the inner drum rotating during operation and the parts if its in- and outflow system not rotating during operation, insofar as they come into contact with product, to consist of plastics and for numerically only a few parts, e.g., injection-molded plastics parts, to be provided overall, apart from any seals which need to be provided. These are preferably the inner drum lower part, the inner drum upper part, the distributor, the precipitating means (preferably the disk insert for solids precipitation), a separating disk and the discharge element. In addition, there are the sealing means with the sealing rings. In this way, a functional centrifuging drum of plastics is provided, which consists of only a very few components, making the production and assembly thereof particularly simple. The separating disk and inner drum upper part elements could also be made in one piece. In this case, the upper drum part would be directly provided with one or more ducts, through which, as with a separating disk or the like, one or more phases may flow from a larger diameter region in the drum to the tip thereof and as far as a discharge line from the rotating system. The splash ring is preferably likewise made of plastics.

It is moreover particularly advantageous for the inner drum lower part and the inner drum upper part to be connected non-detachably together on first assembly, to prevent any attempts to dismantle them and optionally reuse them after inadequate cleaning. Instead, the inner drum is fully disposed of or recycled. A further advantage of this is that sterility is guaranteed. The design is preferably such that, prior to installation and after removal, no air can penetrate from outside into the inner drum.

With the design of the inner drum it is furthermore possible, as in PCT International patent document WO 2014/000829 A1, to design part of the drum or preferably even the entire drum (preferably together with the in- and outflow systems and/or regions) for single use, which is of particular interest and advantage with regard to the processing of pharmaceutical products such as fermentation broths or the like, because it is not necessary to clean the drum after operation to process a corresponding product batch with preferably continuous operation for processing of the product batch, but rather the drum as a whole is replaced. In this way, hygiene problems associated with cleaning are simply eliminated. The parts coming into contact with the product may be fully disposed of or recycled. Disposal is also of particular interest with regard to hazardous substances. It is in turn also conceivable first of all to perform concentration of a product to be processed in a process for clarifying a product and to melt down the inner drum after processing of a batch or for example to dissolve it in an acid or the like in order to recover the heavy material as a residue of this process. By using preferably thin-walled plastics parts, it is additionally possible to keep manufacturing costs relatively low.

It is in this case additionally advantageous and particularly hygienic for the entire drum, in particular also the inflow system and outflow system thereof, to be of sealed construction.

The plastics material used is preferably a recyclable plastics material, in particular PE (polyethylene), PP (polypropylene) or PEEK (polyether ether ketone, in particular partially crystalline). Also feasible are inter alia (and this is not an exhaustive list) the materials PC (polycarbonate), MABS (methyl methacrylate-acrylonitrile-butadiene-styrene), ABS (acrylonitrile-butadiene-styrene) and PSU (polysulfone).

The parts made from plastics may be produced using an injection molding method and optionally be post-machined, for example provided with bores and the like, where necessary. It is however also feasible to produce them using another method, for example a 3D printing method.

Screws and the like may also consist of plastics, but they may also, in particular if they do not come into contact with the product during processing, be made from another material.

### BRIEF DESCRIPTION OF THE DRAWING FIGURES

The invention is described in greater detail below with reference to exemplary embodiments and on the basis of the figures, in which:

FIG. 1 shows in a) a view of a separator according to the invention with a housing shown in section and a drum shown in section and in b) an enlarged view of a portion of a);

FIG. 2 shows in a) a view of a second separator according to the invention with a housing not shown in section and a drum shown in section and in b) an enlarged view of a portion of a);

FIG. 3 shows in a) a view of a third separator according to the invention with a housing shown in section and a drum shown in section and in b) an enlarged view of a portion of a); and

FIG. 4 shows in a) a view of a sub-region of a fourth separator according to the invention with a housing shown in section, an annular cover member shown in section and a drum portion shown in section and in b) an annular cover member similar to the annular cover member of a) in perspective, individual representation with a number of feed and discharge lines connected thereto.

### DETAILED DESCRIPTION

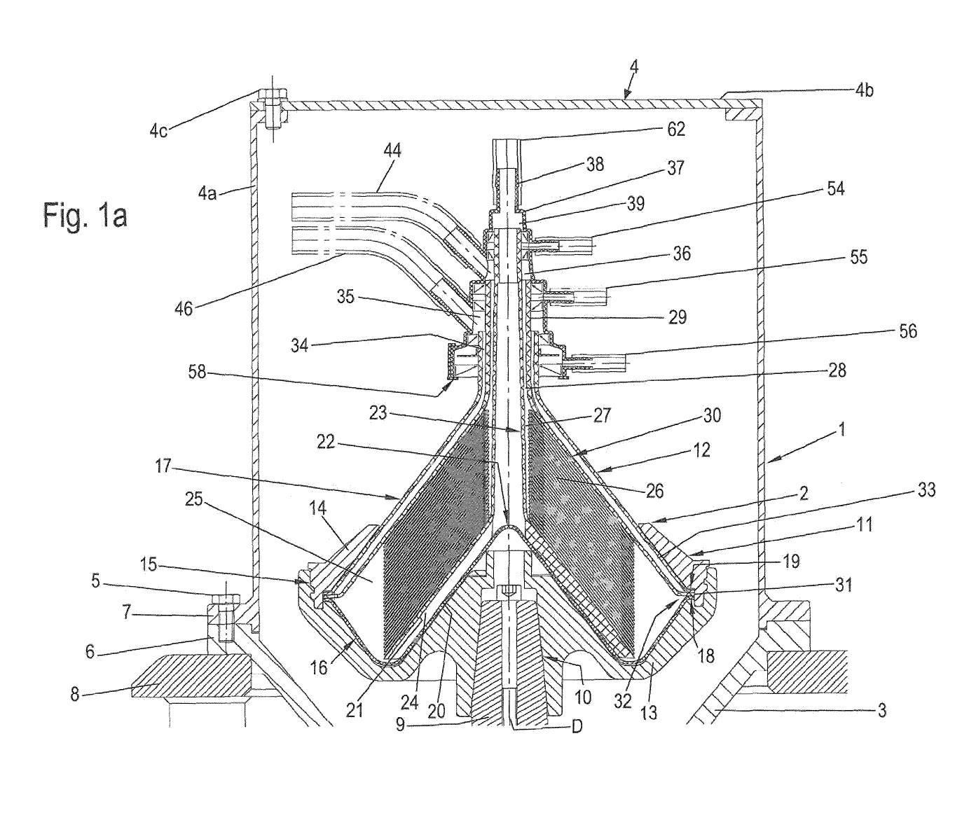

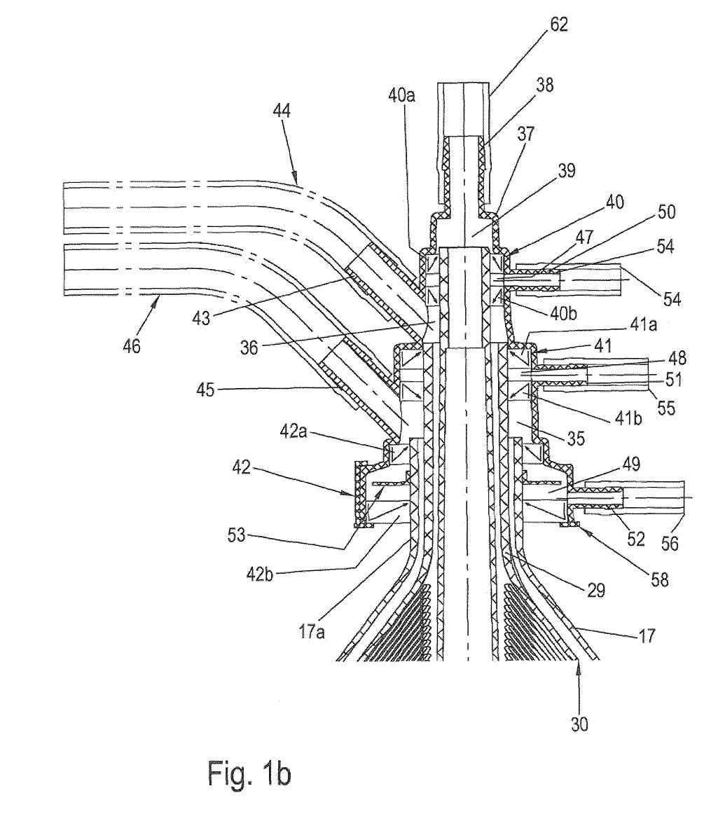

FIG. 1 shows a section through the region of a housing 1 and a drum 2 of a separator according to the invention with which a liquid product may be divided into two phases in the centrifugal field. The drum 2 has a vertical axis of rotation D. Terms such as “upper” or “lower” used below relate to the orientation of elements of the separator relative to this vertical axis of rotation.

The housing 1 comprises a base part 3 and an upper cover 4. These two elements are in this case joined together by one or more screws 5, which pass through bores in superposed flanges 6, 7 of the base part 3 and the cover 4. The housing 1 is in turn supported on a (machine) frame 8, preferably in the region of the flanges 6 and 7. The cover 4 may be of one-piece construction. Here, however, it advantageously consists of two portions 4a and 4b joined together by screws 4c. Division of the cover 4 simplifies handling or exchange of the inner drum 12. The one portion 4a here takes the form of a type of shell spaced from the drum 2 and the other portion 4b takes the form of a type of lid part for the housing 1.

The base part 3 comprises a feedthrough (not shown here) through which passes a rotatable drive spindle 9 comprising a conical vertically upper end 10. A drive motor (not shown here) is preferably arranged directly beneath the base 3. This drive motor serves to drive the drive spindle 9. Alternative configurations are feasible, for example one in which the drive spindle 9 is driven with a drive belt or the like. The drum 2 is in turn placed onto the vertically upper end 10 of the drive spindle 9 so as to be non-rotatable relative to the drive spindle 9, such that it may be set in rotation by the drive spindle 9 and the drive motor. The drive spindle 9 is rotatably mounted. This mounting may be achieved by drive motor bearings or by one or more bearings, in particular rolling bearings. These are not visible here, and in the illustrated design are in any event formed beneath the drum.

The structure of the drum 2 will now be explained in greater detail below. The drum 2 comprises an outer drum 11, which may also take the form of an outer drum portion, and an inner drum 12. The inner drum 12 is inserted exchangeably into the outer drum 11.

The outer drum portion or outer drum 11 and the inner drum 12 preferably consist of different materials. Particularly preferably, the outer drum 11 consists of metal, in particular of steel, and the inner drum 12 consists preferably entirely or at least in part of a plastics material or a plastics composite material.

The outer drum 11 here serves as a type of holder, into which the inner drum 12 is inserted and which at least in places surrounds or encloses the entire circumference of the inner drum 12 in the vertical and/or axial direction. The outer drum 11 and the inner drum 12 are particularly preferably joined non-rotatably together. This may in particular be achieved by a form- and/or force-locking connection between the outer drum 11 and the inner drum 12.

The outer drum 11 comprises an outer drum lower part 13, which may be or here is configured, substantially like the lower drum part of known separators, without an inner drum. The outer drum lower part 13 is placed non-rotatably onto the drive spindle 9 and internally preferably has a single-cone or here particularly preferably double-cone internal shape. The outer drum 11 further preferably comprises an outer drum upper part 14. The outer drum lower part 13 and the outer drum upper part 14 preferably comprise corresponding threads 15, in the region of which they are screwed directly together. Here, the thread of the outer drum lower part 13 takes the form of an internal thread and that of the outer drum upper part 14 that of a corresponding external thread. The diameter of the double-cone drum 2 is at its greatest in the region of the thread.

The outer drum upper part 14 is likewise of conical construction. It takes the form of a ring, which is connected at the bottom non-rotatably with the outer drum lower part 13 (preferably screwed thereinto) and which is open at the top, such that the inner drum 12 projects vertically or axially upwards out of the outer drum upper part 14.

Because the outer drum lower part 13 and the outer drum upper part 14 preferably consist of metal, in particular steel, and preferably at least the lower drum part, like that of a separator drum, is configured without an inner drum 12, they may largely offer the smooth running and stability and reliability of a separator drum of metal.

Because the outer drum 11 externally surrounds the inner drum 12 in places or completely, the outer drum stabilizes the inner drum. In particular, the outer drum 11 advantageously contributes to optimization of the running characteristics of the overall drum 2 when operating at high rotational speed. In addition, the wall thickness of the inner drum 12 may also be selected to be very much thinner than the separator drum consisting of plastics and without an outer drum 11, as proposed in PCT International patent document WO 2014/000829 A1.

The inner drum 12, on the other hand, externally defines the actual separating or centrifuging chamber for centrifugal processing of a flowable product.

The inner drum 12 is configured with regard to its shape in such a way that it preferably rests in largely form-locked manner directly against the inner circumference of the outer drum.

The inner drum 12 comprises an inner drum lower part 16 and an inner drum upper part 17. The inner drum lower part 16 and the inner drum upper part 17 are preferably each of conical configuration, such that a double-cone body is formed. The parts 16 and 17 consist of plastics or a plastics composite material and are joined together in a liquid-tight manner, in particular in upper (inner drum lower part 16) and lower (inner drum upper part 17) flange regions 18, 19.

A bonded joint between the inner drum lower part 16 and the inner drum upper part 17 and optionally further elements of the inner drum 12 is preferably provided, which may, for example, be achieved by melting or indeed by adhesion. However, other types of joint are also feasible, for instance a bayonet closure between the elements inner drum lower part 16 and inner drum upper part 17 to be joined together or a latching connection (not shown here).

Inner portion 20 of the inner drum lower part 16 is adjoined axially at the top by a distributor 21 joined as a separate part or in one piece to the inner drum lower part 16 and coaxially surrounding the axis of rotation D, which distributor is configured to introduce the product to be centrifuged into the inner drum inner chamber or centrifuging chamber 25 and to accelerate the product to be centrifuged in the circumferential direction during rotation of the drum 2.

The distributor 21 comprises a central region 22 to which an inflow pipe 23 leads. Here, the inflow pipe 23 is molded directly axially towards the top to the distributor 21 or formed directly in one piece therewith. The inflow pipe 23 and the distributor 21 form an inflow system preferably advantageously sealed against the surrounding environment. The inflow pipe 23 preferably projects axially upwards out of the inner drum upper part 17 and rotates with the drum 2 during operation.

The distributor 21 leads at the lower end into one or more distributor channels 24, which are formed obliquely relative to the axis of rotation and here likewise lead obliquely into the actual centrifuging chamber 25.

In the centrifuging chamber 25 are arranged precipitating means or clarifying means such as, in particular, a single-part or preferably multipart disk stack 26, which takes the form of a stack of axially spaced separator disks, which have a conical basic shape, and which are preferably placed non-rotatably onto the distributor 21 or the inflow pipe 23. The precipitating means for clarification could also be configured differently, for instance as a ribbed body with radial or arcuate ribs. The separator disks here have the same or different radii.

The distributor 21 may also be formed in one piece with the clarifying means, if the latter takes the form of a clarifying insert of plastics with clarifying chambers as disclosed in German patent document DE 10 2008 052 630 A1. A product introduced into the inner drum inner chamber or centrifuging chamber 25 is divided in the drum 2 into different, preferably two, product phases of different densities.

To discharge the different product phases from the drum 2, an outflow system with two or more outflow regions is used. In this way, a lighter liquid phase flows radially inward from the disk stack 26 and is there passed (see FIGS. 1a and b) in a channel 27 on the outside of the distributor 21 axially upwards into an annular channel 28 (FIG. 1b), which is formed between the outer circumference of the inflow pipe 23 and a pipe piece 29 of larger diameter, which likewise projects from above into the inner drum upper part 17.

At the bottom, a conical plate is placed on, in particular adhered to or molded onto, this pipe piece 29, which conical plate is arranged in the manner of an upper separating disk 30 above the separator disk stack, wherein it is spaced from the upper drum part, such that a gap is formed between the upper drum part and the separating disk. At the lower end (FIG. 1a) a flange-like circumferential edge 31 is here placed between the flange regions 18 and 19 of the inner drum lower part 16 and the inner drum upper part 17 and is there preferably adhesively bonded firmly thereto, stabilizing the arrangement of the separating disk 30 and also lending additional strength to the entire structure.

A heavier liquid phase (or a solids phase which is still just dischargeable, in particular still somewhat flowable) is passed from the region of the greatest inner circumference of the drum interior chamber through one or more bores 32 in the radially outer region of the separating disk into the gap 33 functioning as a channel between the inner drum upper part 17 and the separating disk 30, preferably as far as into a second annular channel 34 (or into one or more channels, which are preferably spaced by ribs) between the pipe piece 29 surrounding the inflow pipe and an axial pipe extension 17a of the inner drum upper part 17 (FIGS. 1a and 1b).

The heavier and lighter liquid phases flow according to FIGS. 1a and 3a and 4a in each case out of the annular channels 28 and 34 upwards in each case into annular chambers 35 and 36 arranged axially one above the other in an annular cover member 37, which is supported or attached non-rotatably (in a manner to be explained in greater detail) on/to an abutment (see also FIGS. 1b, 3a, 3b, 4a, 4b). It is advantageous that in this way nozzles or the like leading radially out of the drum for solids discharge are dispensed with, such that there is no contact for a phase of the product to be processed between the interior of the (inner) drum 2 and the drum surroundings in the container or housing 1.

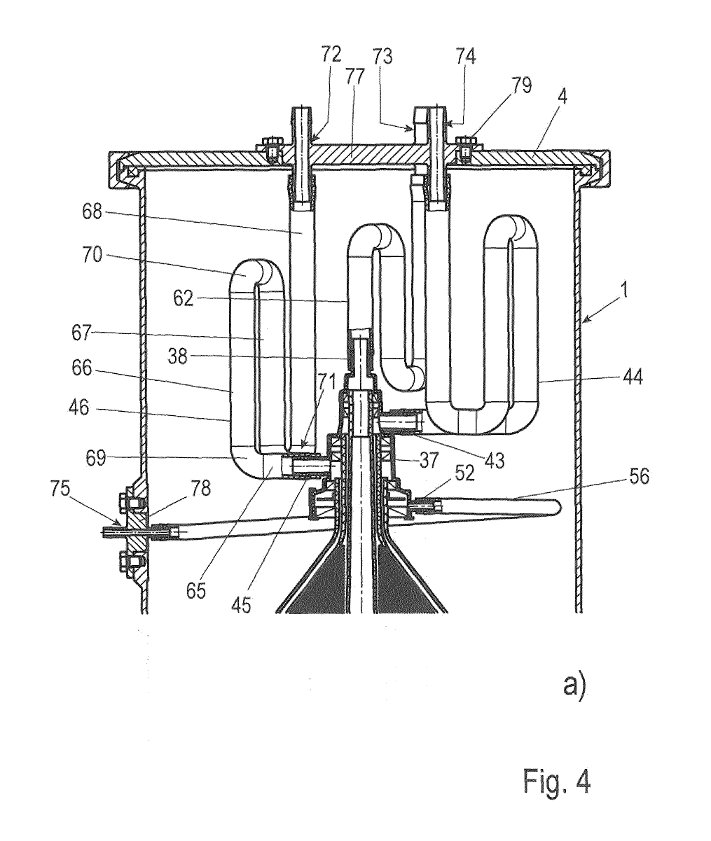

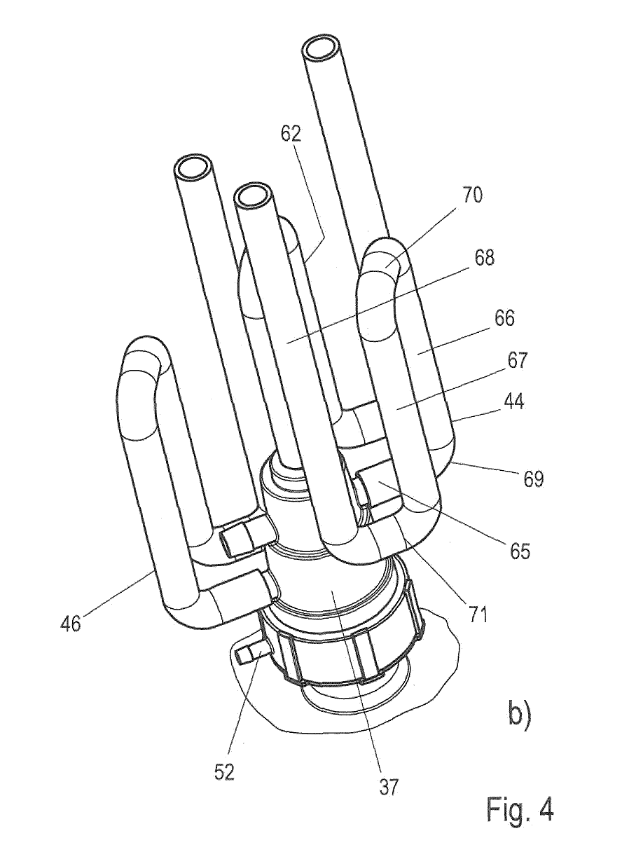

The annular cover member 37 is preferably (see in addition to FIG. 1a also FIG. 1b and the further exemplary embodiments of FIG. 4a and FIG. 4b (only individual ones of the reference signs used below are repeated therein) of stepped construction and has in its vertically uppermost region a connection port 38 as a connection option for an inflow line 62.

The annular cover member 37 widens out stepwise from the connection port 38. The internally hollow connection port 38 leads into an axially uppermost annular space 39 at the inner circumference of the annular cover member 37 into which the upper end of the inflow pipe 23 extends axially from below, which upper end rotates with the drum when the centrifuge is in operation and which leads into the annular space 39 but is spaced from the annular cover member 37 at every point of the annular chamber 39.

In this way, the inflowing product to be processed by centrifuging is simply transferred into the rotating system. At the bottom, each of the annular chambers 39, 35, and 36 is preferably defined respectively by in each case one sealing arrangement 40, 41, and 42 consisting of one or more (here two, then axially spaced) sealing rings 40a and 40b; 41a and 41b; and 42a and 42b, which are arranged between the inner wall and the outer wall of the corresponding annular chamber.

Beneath the uppermost sealing arrangement 40 between the inflow pipe 23 and the annular cover member 37, the annular cover member 37 widens out further at a subsequent step. Between the inflow pipe 23 and the inner circumference of the annular cover member 37, the middle annular chamber 36 is formed between the outer circumference of the inflow pipe 23 and the inner circumference of the annular cover member 37 beneath the uppermost sealing arrangement 40 and above the middle sealing arrangement 41. This serves to discharge the light liquid phase. To this end, a connection port 43 may be formed on the annular cover member 37 which extends preferably radially or obliquely away from the rest of the annular cover member 37. A discharge line 44 is connected to the connection port 43.

The pipe end of the pipe piece 29, which here in a preferred configuration adjoins the separating disk 30 axially towards the top, leads from below into this annular chamber 36. The middle sealing arrangement 41 is arranged between the outer circumference of the pipe piece 29 and the inner circumference of the annular cover member 37.

Beneath the middle sealing arrangement 41, the annular cover member 37 again widens out at a subsequent step. Between the outer circumference of the pipe piece 29 and the inner circumference of the annular cover member 37, the annular chamber 35 is formed between the outer circumference of the pipe piece 29 and the inner circumference of the annular cover member 37 beneath the middle sealing arrangement 41 and above the lower sealing arrangement 42. This lower annular chamber 35 serves to discharge a liquid phase that is heavier than the lighter phase from the rotating system. To this end, a further connection port 45 is formed on the annular cover member 37 and which extends away preferably radially (here obliquely) from the rest of the annular cover member 37. A discharge line 46 (which here is again a hose) is connected to the connection port 45. Between the outer circumference of the vertically upper pipe extension 17a of the inner drum upper part 17 and the inner circumference of the annular cover member 37, the lower sealing arrangement 42 is arranged.

A leakage chamber or respective leakage chambers 47, 48, and 49 may be formed in each case between the two seals 40a and 40b; 41a and 41b; 42a and 42b of one or more of the sealing arrangements 40, 41, and 42, from which chamber leakage fluid may flow out of the rotating system through connections, in particular connection ports 50, 51, and 52, wherein lines 54, 55, and 56 and then optionally leakage vessels (not shown here) are in turn connected to the connection ports 50, 51, and 52.

It is in particular also feasible for such a leakage chamber 49 to be formed only between the two sealing rings 42a and 42b of the bottommost sealing arrangement 42, which chamber then comprises the connection (connection port 52). This is possible since leakage liquid is in this case in any event discharged from this single leakage chamber 49. Such a configuration is shown in FIGS. 4a and 4b.

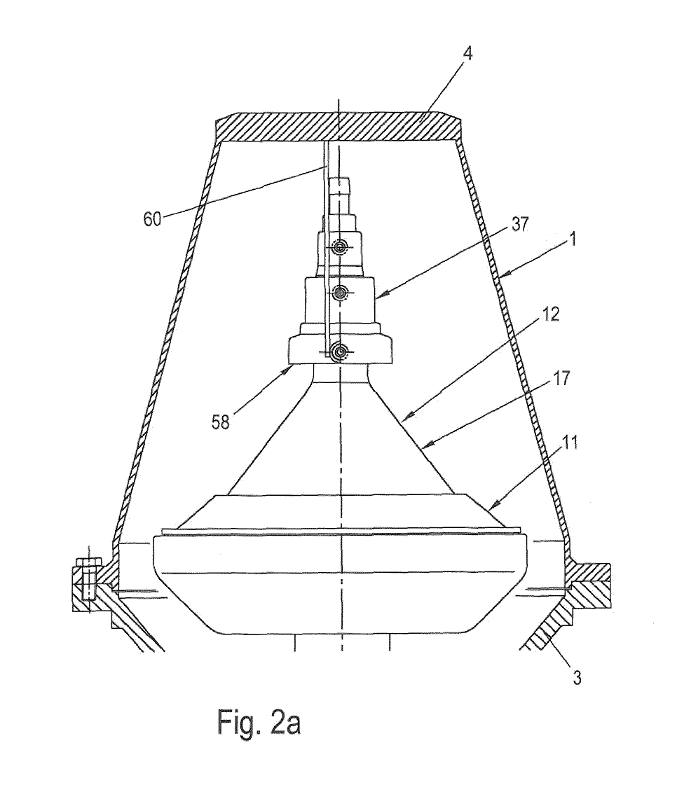

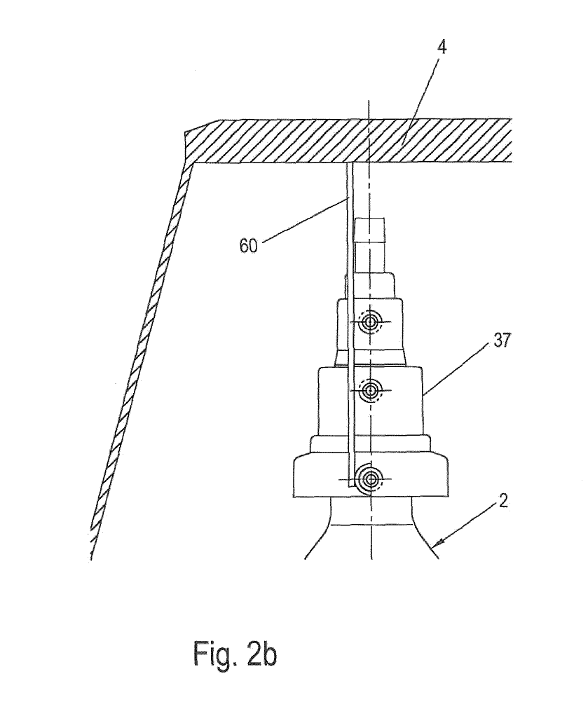

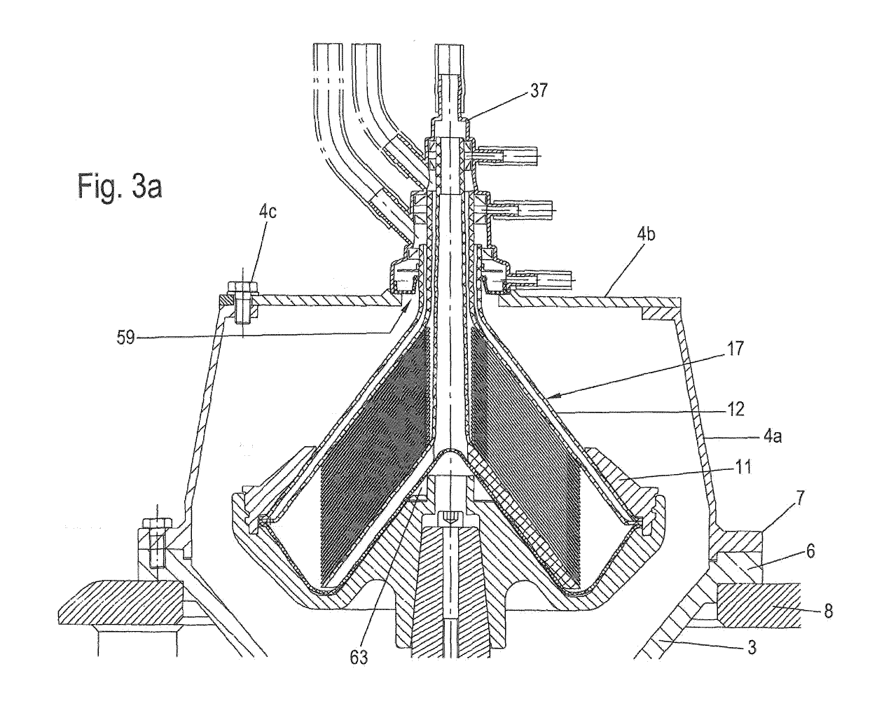

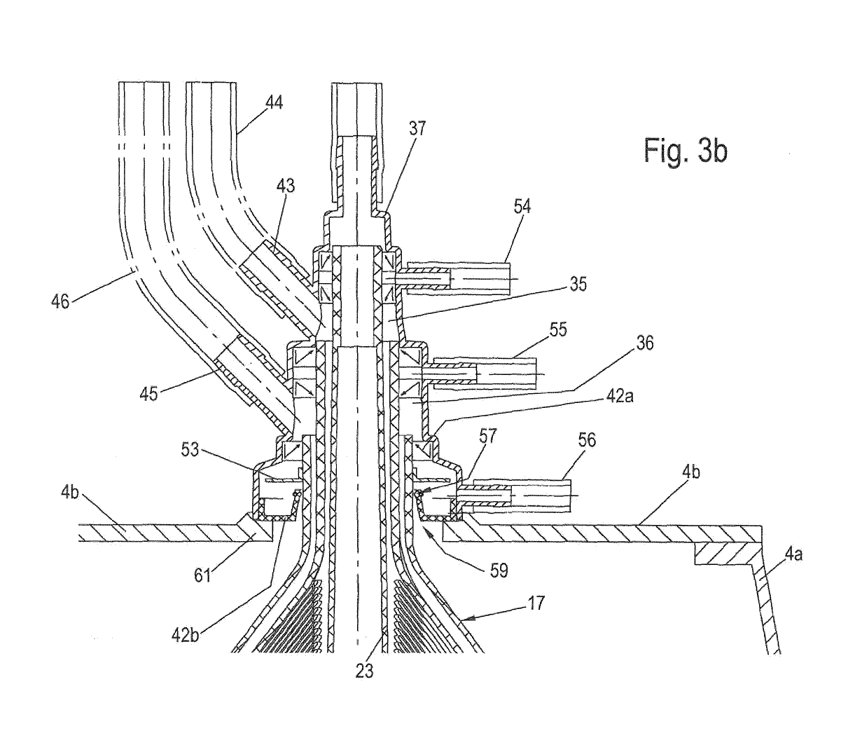

In this respect, the structure in FIG. 2 and FIG. 3 as well as FIG. 4 may be selected to be the same as in FIGS. 1a and b.

It is advantageous if, to ensure good discharge of the leakage liquid from the leakage chamber 49, a splash ring 53 is formed in the leakage chamber 49. This preferably consists of plastics. It may however also consist of another material. The splash ring 53 is formed, in particular arranged, between the upper seal 42a and the lower seal 42b of the bottommost sealing arrangement. The splash ring 53 is preferably an annular disk fastened at its inner circumference non-rotatably to the inner drum upper part 17, in particular to the tubular extension 17a thereof, such that it rotates therewith when in operation.

Leakage liquid flowing from above against the splash ring 53 is spun radially outwards in the leakage chamber 49 by the splash ring 53 and then flows away through the connection port 52 of this leakage chamber.

In each case, one of the lines 54, 55, and 56 is placed onto the connection port(s) 50, 51, and 52, in particular adhesively bonded on as a hose or the like, in order to discharge the leakage liquid in a manner not described in any further detail here.

The splash ring 53 is a simple way of ensuring that no leakage liquid is able to reach the bottommost sealing ring 42b.

The in each case two sealing rings 40a and 40b; 41a and 41b; 42a and 42b are preferably in each case provided as sealing arrangements 40, 41, and 42, in particular in the manner of floating ring seals.

According to FIGS. 3a and 3b, as a modification of the drum structure of FIGS. 1a and 1b, FIG. 2 and FIGS. 4a and 4b the bottommost sealing ring 42b is configured such that an annular gap 57 is formed on the radially inward rotating part located inwardly thereon. The gap preferably comprises a larger gap width than an optionally remaining minimal residual gap at the other sealing rings 40a to 42a relative to rotating elements of the drum/on the drum 2.

The annular gap 57 preferably comprises all round a radial extent or gap width of more than 0 mm and less than 5 mm. The gap width preferably amount to between 0.2 mm and 1 mm. This gap width of the annular gap 57 ensures (since the bottommost sealing ring 42b is connected non-rotatably to the annular cover member 37 which does not rotate during operation and since the annular gap 57 is formed towards the inner drum 17) that at the bottommost sealing ring 42b no problematic evolution of heat may arise through contact with rotating parts of the drum (here in particular: inner drum upper part 17 or axial pipe extension 17a, pipe piece 29, and inflow pipe 23).

According to the variants of FIGS. 1 and 2 (visible in FIGS. 1a and 1b), provision is made for the annular cover member 37 to have a radial annular portion 58 at its axially lower end, which extends a little radially inwards, such that the bottommost sealing ring 42b may rest radially at the bottom on this annular portion 58. The annular portion 58 may also take the form of part of a clip, which is placed, preferably latched, onto the annular cover member 37. According to FIGS. 1 and 2, the annular cover member 37 is terminated towards the bottom by the annular portion 58.

According to FIG. 1a and FIG. 2a, the housing 1 and in particular the upper cover 4 thereof are dimensioned such that the entire drum 2 with the outer drum 11 and the inner drum 12 is arranged inside the housing 1 (under the cover 4). The housing 1, in particular the cover 4, optionally comprises one or more feedthroughs for in- and outflow lines, for example for the hoses 44, 46, 62, 54, 55, and 56, only at locations not shown here. The base part 3 may moreover comprise the described feedthrough for the drive spindle 9.

The cover 4 of FIG. 1a again has a divided configuration. Here it comprises the upper (lid) portion 4a, which is attached to the (shell) portion 4b, for example again by means of the screws 4c. This design is very simple, since the entire drum is simple and hygienically arranged inside the housing 1 and may rotate freely therein and perform precession movements, which the annular cover member 37 may also carry out.

To ensure that the annular cover member 37 does not co-rotate with the drum 2, it is advantageous to provide a supporting device, which supports the annular cover member 37 substantially non-rotatably on the housing 1.

This supporting device is intended to be mobile in itself to a limited degree or movable to a limited degree relative to the drum 2 and/or the housing 1. Thus, although a small amount of relative motion is feasible between the housing 1 and the annular cover member 37, the annular cover member, optionally after traversing a small angle which results from the limited mobility, does not co-rotate with the drum 2.

In the simplest configuration, the supporting device may be formed of the one or the plurality of feed and/or discharge lines 44, 46, 54, 55, 56, and 62, in particular hoses/pipes/lines, which is/are then accordingly made at least sufficiently rigid for them to be able to ensure support at the feedthrough(s) of the housing 1 (this support is not shown in FIGS. 1a and 1b, see however FIGS. 4a and 4b) but on the other hand still mobile to a limited degree such that precession movements of the drum 1 are impeded as little as possible or not at all.

According to one variant, one or more of the feed and/or discharge lines are formed on the annular cover member 37 (provided in FIGS. 4a and b by way of example with reference signs 44, 46, 56, and 62) to this end as singly or repeatedly bent hoses. It is furthermore advantageous for one or more of the feed and/or discharge lines to be formed on the annular cover member 37 (here by way of example the elements provided with reference signs 44, 46, 56, 62) as dimensionally stable hoses.

FIGS. 4a and 4b are intended to illustrate this. It is here to this end advantageous in a preferred configuration for individual ones, a plurality or all of the hoses/discharge lines/lines 44, 46, 62 to have at least two or more straight portions 65, 66, 67, 68, which are joined together via a bend or a plurality of bends 69, 70, 71 here of 90° or 180°. In this way, joint regions are created between the straight portions 65, 66, 67, 68, which allow limited relative movements of the straight portions 65, 66, 67, 68 relative to one another. The straight portions 65, 66, 67, 68 are in this respect swivellable relative to one another to a limited degree.

As a result of the repeatedly bent hoses, radial movements of the annular cover member 37, caused by the rotating system of the drum 2, are in this way advantageously absorbed. In this way, a high level of rigidity is achieved axially for support of the annular cover member 37 on the housing 1 and a high level of flexibility radially. The ratio of axial to radial rigidity ranges from twice to 1000 times, preferably in the direction of pull. A hose may optionally be additionally secured against torsion by a flexible element or a plurality of flexible elements such as straps fastened to the housing and to the corresponding hose. The hoses may cross one another. They may extend in any spatial direction.

The one ends of the hoses/discharge lines/lines 44, 46, 56, and 62 are attached to the annular cover member 37. The other ends of the hoses/discharge lines/lines 44, 46, 56, and 62 are placed onto the ports of the feedthroughs 72, 73, 74, and 75 located inside the housing 1. The feedthroughs 72, 73, 74, and 75 may comprise corresponding outer ports outside the housing 1, to which further hoses/lines may be connected. In addition, the housing 1 may have one or more passage opening(s) in the region of each feedthrough 72, 73, 74, and 75 or for a plurality of the feedthroughs together, this/these being closable with a lid part 77 and 78. The respective lid part 77 and 78 may, for example, be attachable or attached to the housing 1 for example with screws 79, in order to close the respective passage opening (see FIGS. 4a and b).

According to FIGS. 2a and b, the supporting device is formed in addition or alternatively by a type of supporting yoke 60. This supporting yoke 60 connects the annular cover member 37 and the housing 1, here the cover 4, to one another. According to one advantageous variant, the supporting yoke 60 preferably extends vertically and lies parallel to the axis of rotation D. Preferably, the supporting yoke 60 is in itself resiliently mobile to a limited degree. It may also be arranged movably to a limited degree at one or both ends, i.e., at the cover 4 and at the annular cover member 37, such that it on the one hand prevents co-rotation of the annular cover member 37 with the drum 2 and on the other hand nevertheless allows the annular cover member 37 to carry out precession movements of the drum 2. It is, for example, advantageous for the supporting yoke to extend substantially vertically between its ends. In this way, the evolution of heat at the sealing arrangements 40, 41, and 42, in particular as in FIG. 1b or 2b, is kept low, since only little in the way of relative movements may arise in the radial direction between these sealing arrangements 40, 41, and 42 and the annular cover member 37.

According to FIGS. 3a and 3b, the bottom of the annular cover housing 37 terminates radially at the housing 1, in particular at an inner radial peripheral region 61 of a preferably annular opening 59 in the cover 4, here the portion 4b. The lower sealing ring 42b at which the gap is formed radially inwardly towards the drum also rests at this point. The cover 4 is made vertically correspondingly shorter. The cover 4 here also advantageously consists of two portions 4a and 4b joined together by screws 4c. Division of the cover 4 simplifies handling or exchange of the inner drum 12. An upper region on the drum 2 passes through the opening 59, such that the annular cover member 37 lies substantially or even preferably wholly vertically above the cover 4.

To join the inner drum 12 and the outer drum 11 together non-rotatably but detachably in a simple manner at a standstill, provision is preferably made for the inner drum 12 to be connected in form- and/or force-locked manner with the outer drum 11. A force-locked connection may be simply achieved in that the flange regions 18 and 19 and the outer edge 31 of the separating disk 30 extend as far as into the threaded joint region between the outer drum lower part 13 and the outer drum upper part 14, where they in each case rest on steps of these parts and are clamped by screwing between the upper drum part and the lower drum part when the former is screwed into the latter (FIG. 1a). In addition, form-locking means may be provided, such as ribs 63 on the outer circumference of the inner drum and corresponding grooves on the inner circumference of the outer drum 11, which engage with one another and in this way join the two elements, inner drum 12 and outer drum 11, together non-rotatably. In operation, the inner drum 12 will lie in radially flaring manner against the inner circumference of the outer drum 11, so improving torque transmission and rotating drive of the inner drum 12 by the driven outer drum 11. It might alternatively also be feasible to join the parts of the outer drum together in a different way, for instance with threaded bolts or the like or by means of a bayonet fitting.

In this way, some or preferably even all of the regions of the rotating system coming into contact with the product consist(s) of plastics or plastics composite material, in particular the inner drum lower part 16 and the inner drum upper part 17. Particularly preferably, the separator disks additionally consist of plastics and also preferably all or virtually all of the regions of the inflow system and of the outflow system coming into contact with the product, also insofar as these do not rotate when in operation. In this way, the inner drum 12 may be disposed of after processing of a sufficiently large product batch. In contrast, the preferably metallic outer drum 11 is re-used. Since it cannot come into contact with product when in operation, cleaning thereof is very simple or less important. Due to the outer drum 11, the inner drum 12 may be really thin-walled. In the event of complete disposal, very little plastics waste is accordingly generated.

FIGS. 1a and 3a each show an embodiment as a two-phase separating machine (separation of a product into the phases: “liquid/liquid”); three-phase machines (for separation into three phases) are likewise feasible (not shown here). The product is preferably but not necessarily a fermentation broth to be concentrated.

In this way, preferably the entire inner drum together with the in- and outflow system is preferably designed as an exchangeable preassembled module of plastics or a plastics composite material. The bearing preferably consists of plastics or metal and is optionally disposed of or recycled when the inner drum is exchanged.

The outer drum portion serves substantially as a holder for the inner drum 12, which in particular improves the running characteristics of the inner drum 12.

FIGS. 1b and 3a and 4a each show the upper portion of the annular cover member 37 with the connection port 38 as a connection option for the preferably hose-like inflow line 62 and an upper portion of the inflow pipe and the upper sealing arrangement 40. The hose-like inflow line 62 (and similarly the hose-like outflow lines 44 and 46 at the further connection ports 43 and 45) is/are preferably adhesively bonded thereto as a preassembly. The hoses may be adhered to the ends remote from the connection ports. Prior to commissioning, the stuck-together ends are cut off and welded to a piece of hose, which comes from the fermenter for example. Other variants for joining the hoses and ports and for closing optionally open line ends are also feasible. For instance, coupling elements for example of latching configuration are feasible, as is closure of the ends with cable ties or similar elements.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### REFERENCE SIGNS

Housing 1
Drum 2
Base part 3
Cover 4
Portions 4a, b
Screws 4c
Screws 5
Flanges 6, 7
Machine frame 8
Drive spindle 9
Conical end 10
Outer drum 11
Inner drum 12
Outer drum lower part 13
Outer drum upper part 14
Thread 15
Inner drum lower part 16
Inner drum upper part 17
Axial pipe extension 17a
Flange regions 18, 19
Inner portion 20
Distributor 21
Region 22
Inflow pipe 23
Distributor channels 24
Centrifuging chamber 25
Disk stack 26
Channel 27
Annular channel 28
Pipe piece 29
Separating disk 30
Circumferential edge 31
Bores 32
Gap 33
Annular channel 34
Annular chambers 35, 36
Annular cover member 37
Connection port 38
Annular chamber 39
Sealing arrangement 40, 41, 42
Seals 40a, 40b; 41a, 41b; 42a, 42b
Connection port 43
Discharge line 44
Connection port 45
Discharge line 46
Leakage chambers 47, 48, 49
Connection ports 50, 51, 52
Splash ring 53
Line 54, 55, 56
Annular gap 57
Annular portion 58
Opening 59
Supporting yoke 60
Peripheral region 61
Inflow line 62
Ribs 63
Straight portions 65, 66, 67, 68
Bends 69, 70, 71
Feedthroughs 72, 73, 74, 75
Lid part 77, 78
Screws 79
Vertical axis of rotation D

1-35. (canceled)

36. A separator for centrifugal processing of a flowable product, the separator comprising:
a rotatable drum with vertical axis of rotation, the rotatable drum comprising a centrifuging chamber and having a maximum radial diameter, wherein the rotatable drum comprises an outer drum and an inner drum arranged in an outer supporting device;
an annular cover arranged on an upper end of the rotatable drum configured as a part that does not rotate with the rotatable drum during operation of the separator, wherein the annular cover is supported with a supporting mechanism having limited mobility relative to the annular cover;
at least one sealing arrangement with two sealing rings arranged between the rotatable drum and the annular cover;
a housing dimensioned such that an entirety of the rotatable drum, including the outer drum and the inner drum, is arranged inside the housing.

37. The separator of claim 36, wherein the housing comprises one or more feedthroughs for feed and/or discharge lines, wherein the one or more feed and/or discharge lines constitute the supporting mechanism.

38. The separator of claim 37, wherein the feed and/or discharge lines are flexible hoses.

39. The separator of claim 36, wherein the sealing arrangement is one of a plurality of sealing arrangements, wherein are one or more slip ring seals.

40. The separator of claim 36, wherein the supporting mechanism is a supporting yoke, which is resiliently mobile to a limited degree and/or which is arranged to be mobile to a limited degree at one or both ends.

41. The separator of claim 40, wherein the supporting yoke is vertically oriented between its ends.

42. A separator for centrifugal processing of a flowable product, the separator comprising:
a rotatable drum with vertical axis of rotation, the rotatable drum comprising a centrifuging chamber and having a maximum radial diameter;
an annular cover arranged on an upper end of the rotatable drum and configured as a part that does not rotate with the rotatable drum during operation of the separator; and
at least one sealing arrangement with two sealing rings arranged between the rotatable drum and the annular cover,
wherein a leakage chamber is arranged between the two sealing rings of the at least one sealing arrangement, wherein the leakage chamber includes a discharge line, and a splash ring, which is fastened in a non-rotatable manner to the rotatable drum, arranged in the leakage chamber.

43. The separator of claim 42, wherein the sealing arrangement is a vertically bottommost sealing arrangement of a plurality of sealing arrangements arranged vertically one above another.

44. The separator of claim 42, wherein the splash ring is an annular disk having an inner circumference fastened non-rotatably to the rotatable drum such that the splash ring rotates with the rotatable drum during operation.

45. The separator of claim 43, wherein a bottommost one of the two sealing rings is non-rotatably arranged internally on the annular cover and an annular gap is formed between the bottommost one of the two sealing rings of the at least one sealing arrangement or the plurality of sealing arrangements and the rotatable drum.

46. The separator of claim 45, wherein the annular gap has a radial gap width between 0.2 mm and 1 mm.

47. The separator of claim 42, wherein the rotatable drum comprises an outer drum and an inner drum arranged in an outer supporting device.

48. The separator of claim 42, wherein the separator comprises a housing.

49. The separator of claim 48, wherein the housing is dimensioned such that an entirety of the rotatable drum, with the outer drum and the inner drum, is arranged inside the housing.

50. The separator of claim 48, wherein the annular cover is supported non-rotatably on the housing

51. The separator of claim 48, wherein the annular cover is supported non-rotatably on the housing via a limited mobility mechanism.

52. The separator of claim 48, wherein the housing comprises one or more feedthroughs coupled to feed and/or discharge lines to/from the annular cover, wherein one or more of these feed and/or discharge lines is the limited mobility mechanism.

53. The separator of claim 52, wherein the feed and/or discharge lines are guided at one end to the annular cover and fastened to the annular cover and the feed and/or discharge lines are each secured at their other end to a corresponding feedthrough of the housing or pass therethrough.

54. The separator of claim 52, wherein individual or multiple feed and/or discharge lines are flexible hoses.

55. The separator of claim 52, wherein individual or multiple feed and/or discharge lines are dimensionally stable hoses.

56. The separator of claim 52, wherein individual or multiple feed and/or discharge lines are hoses having a number of bends.

57. The separator of claim 52, wherein individual or multiple feed and/or discharge lines are hoses, which have alternately straight portions and bends.

58. The separator of claim 52, wherein individual or multiple feed and/or discharge lines have lower rigidity in a radial direction than in an axial direction relative to the vertical axis of rotation of the rotatable drum when installed between annular cover and housing.

59. The separator of claim 47, wherein the annular cover forms a preassembled, exchangeable unit with the inner drum.

60. The separator of claim 43, wherein the one or more sealing arrangements are one or more slip ring seals.

61. The separator of claim 42, wherein the rotatable drum consists wholly or in part of plastics or a plastics composite material.

62. The separator of claim 48, wherein the annular cover is secured directly to the housing.

63. The separator of claim 51, wherein the limited mobility mechanism is a supporting yoke, which is resiliently mobile to a limited degree and/or which is arranged to be mobile to a limited degree at an end attached to the one or both ends.

64. The separator of claim 63, wherein the supporting yoke is vertically oriented between its ends.

65. The separator of claim 47, wherein the outer drum lower part and the outer drum upper part are fixed to one another by a threaded mechanism.

66. The separator of claim 47, wherein the inner drum lower part and the inner drum upper part are joined together in a non-dismantable manner.

67. The separator of claim 47, wherein the inner drum lower part and the inner drum upper part are adhesively bonded or welded together.

68. The separator of claim 47, wherein the outer drum is drivable by a drive motor.

69. The separator of claim 47, wherein the outer and inner drum upper part and the outer and inner drum lower part are conical.

70. The separator of claim 47, wherein an entirety of the inner drum and an in- and out-flow system are an exchangeable, preassembled module.
